(19) United States
(12) Patent Application Publication
(10) Pub. No.: US 2015/0026057 A1
(43) Pub. Date: Jan. 22, 2015

(54) COMPLETING MOBILE BANKING TRANSACTION WITH DIFFERENT DEVICES

(71) Applicant: BANK OF AMERICA CORPORATION, Charlotte, NC (US)

(72) Inventors: Matthew A. Calman, Charlotte, NC (US); Dipika Jain, Charlotte, NC (US); William Kelley, Charlotte, NC (US); Chris Purvis, Waxhaw, NC (US); Michael E. Toth, Charlotte, NC (US)

(21) Appl. No.: 13/946,581

(22) Filed: Jul. 19, 2013

(51) Int. Cl. G06Q 20/32

(52) U.S. Cl. CPC G06Q 20/3223; G06Q 40/02
USPC 705/42

(57) ABSTRACT

Embodiments of the present invention relates to systems, computer-implemented methods, and computer program products for completing a mobile banking transaction at a trusted location. In some embodiments, the system is configured to: (a) initiate, via a mobile device, a transaction request for a mobile banking transaction; (b) store the transaction request for the mobile banking transaction in a queue for mobile banking transaction requests; (c) retrieve from the queue, using a computing device, the transaction request for the mobile banking transaction, wherein the computing device is different from the mobile device; and (d) complete, using the computing device, the transaction request for the mobile banking transaction.

### BACKGROUND

As a result of an increase in wireless connectivity, users of mobile devices can easily access the Internet in order to perform regular tasks, activities, and even perform transactions from a multitude of locations. However, the increased wireless connectivity has also led to an increased possibility, in some instances, that information being transmitted via the wireless connection may be intercepted or intentionally misappropriated by someone other than the user or an intended recipient of the information from the user. The possibility is particularly heightened when a user chooses to perform or engage into a financial transaction using a wireless connection that is not secured or is, otherwise, not a trusted connection. A lack of security in the wireless connection or the lack of any indication that the connection is safe to use for performing a financial transaction can cause a user to be apprehensive in using his mobile device for the financial transaction. As such, there is a need to provide systems, methods, apparatus, and computer program products for allowing a user to use a mobile device for performing transactions over a reliable or a trusted connection.

### BRIEF SUMMARY

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Brief Summary of Completing Mobile Banking Transaction From A Trusted Location

Some embodiments of the present invention provide a system for completing a mobile banking transaction at a trusted location or via a trusted connection that includes: a mobile device; a storage device; and a module stored in the storage device, where the module comprises executable instructions that when executed by the processing device causes the processing device to: (a) receive, via the mobile device, input relating to one or more user-designated one or more trusted locations or one or more user-designated trusted connections for completing a mobile banking transaction using the mobile device; (b) receive, via the mobile device, input from the user relating to a transaction request for a mobile banking transaction; (c) determine whether the mobile device is located at one of the one or more user-designated trusted locations or has access to one of the one or more user-designated trusted connections for completing the mobile banking transaction; and (d) complete the transaction request by transmitting the transaction request over a wireless connection associated with the one or more user-designated trusted locations or the one or more user-designated trusted connections based at least partially on determining that the mobile device is located at the one or more user-designated trusted location or does have access to the one or more user-designated trusted connections for completing the mobile banking transaction, or store the transaction request in a queue for mobile banking transactions on the mobile device based at least partially on determining that the mobile device is not located at the one or more user-designated trusted locations or does not have access to one or more user-designated trusted connections for completing the mobile banking transaction.

In some embodiments of the system, the determining whether the mobile device is located at one of the one or more user-designated trusted locations comprises: determining, using a position device, a location of the mobile device that received the transaction request; and comparing the determined location of the mobile device to the one or more user-designated trusted locations.

In some embodiments of the system, the determining whether the mobile device has access to the one or more user-designated trusted connections comprises: using the mobile device to detect wireless connections or wireless networks accessible for use by the mobile device for completing the transaction request; and comparing the detected wireless connections or wireless networks to the one or more user-designated trusted connections.

In some embodiments of the system, the processing device is further configured to provide an alternate transaction request completion process for completing the transaction request, via the mobile device, based at least partially on determining that the mobile device is not at one of the one or more user-designated trusted locations or determining that the mobile device does not have access to one of the one or more user-designated trusted connections.

In some embodiments of the system, the transaction request for the mobile banking transaction is a financial transaction including one or more of a fund transfer, a balance transfer, a checking an account balance, a bill payment, a financial account setup, an opening a new financial account, electronically depositing a check or negotiable instrument, and/or an ordering checks.

In some embodiments of the system, the processing device is further configured to: receive, via the mobile device, one or more user-designated non-trusted locations and/or one or more user-designated non-trusted connections for not completing the transaction request for a mobile banking transaction and storing the transaction request based at least partially on determining that the mobile device is located at one of the one or more user-designated non-trusted locations or that the mobile device has access to one of the one or more user-designated non-trusted connections.

In some embodiments of the system, the processing device is further configured to: present to the user, via the mobile device, two or more wireless connections when processing device determines that the mobile device is at one of the one or more user-designated trusted location having two or more wireless connections; and receiving a selection, via the mobile device, of one of the two or more wireless connections for completing the transaction request for the mobile banking transaction.

In some embodiments a computer-implemented method for completing a mobile banking transaction at a trusted location or via a trusted connection is provided that includes: providing a computer processor executing non-transitory computer-readable instruction code specifically structured to cause the computer processor to: (a) receive, via a mobile device, input relating to one or more user-designated one or more trusted locations or one or more user-designated trusted connections for completing a mobile banking transaction using the mobile device; (b) receive, via the mobile device, input from the user relating to a transaction request for a mobile banking transaction; (c) determine whether the mobile device is located at one of the one or more user-designated trusted locations or has access to one of the one or more user-designated trusted connections for completing the mobile banking transaction; and (d) complete the transaction request by transmitting the transaction request over a wireless connection associated with the one or more user-designated trusted locations or the one or more user-designated trusted connections based at least partially on determining that the mobile device is located at the one or more user-designated trusted location or does have access to the one or more user-designated trusted connections for completing the mobile banking transaction, or store the transaction request in a queue for mobile banking transactions on the mobile device based at least partially on determining that the mobile device is not located at the one or more user-designated trusted locations or does not have access to one or more user-designated trusted connections for completing the mobile banking transaction.

In some embodiments of the method, the determining whether the mobile device is located at one of the one or more user-designated trusted locations comprises: determining, using a position device, a location of the mobile device that received the transaction request; and comparing the determined location of the mobile device to the one or more user-designated trusted locations.

In some embodiments of the method, the determining whether the mobile device has access to the one or more user-designated trusted connections comprises: using the mobile device to detect wireless connections or wireless networks accessible for use by the mobile device for completing the transaction request; and comparing the detected wireless connections or wireless networks to the one or more user-designated trusted connections.

In some embodiments of the method, the computer processor is further executing computer-readable instruction code specifically configured to cause the computer processor to provide an alternate transaction request completion process for completing the transaction request, via the mobile device, based at least partially on determining that the mobile device is not at one of the one or more user-designated trusted locations or determining that the mobile device does not have access to one of the one or more user-designated trusted connections.

In some embodiments of the method, the transaction request for the mobile banking transaction is a financial transaction including one or more of a fund transfer, a balance transfer, a checking an account balance, a bill payment, a financial account setup, an opening a new financial account, electronically depositing a check or negotiable instrument, and/or an ordering checks.

In some embodiments of the method, the computer processor is further executing computer-readable instruction code specifically configured to cause the computer processor to receive, via the mobile device, one or more user-designated non-trusted locations and/or one or more user-designated non-trusted connections for not completing the transaction request for a mobile banking transaction and storing the transaction request based at least partially on determining that the mobile device is located at one of the one or more user-designated non-trusted locations or that the mobile device has access to one of the one or more user-designated non-trusted connections.

In some embodiments of the method, the computer processor is further executing computer-readable instruction code specifically configured to cause the computer processor to present to the user, via the mobile device, two or more wireless connections when processing device determines that the mobile device is at one of the one or more user-designated trusted location having two or more wireless connections; and receiving a selection, via the mobile device, of one of the two or more wireless connections for completing the transaction request for the mobile banking transaction.

In some embodiments of the present invention a computer program product for completing a mobile banking transaction at a trusted location or via a trusted connection is provided that includes a non-transitory computer-readable medium, wherein the non-transitory computer-readable medium comprises one or more computer-executable program code portions that, when executed by a computer, cause the computer to: (a) receive, via a mobile device, input relating to one or more user-designated one or more trusted locations or one or more user-designated trusted connections for completing a mobile banking transaction using the mobile device; (b) receive, via the mobile device, input from the user relating to a transaction request for a mobile banking transaction; (c) determine whether the mobile device is located at one of the one or more user-designated trusted locations or has access to one of the one or more user-designated trusted connections for completing the mobile banking transaction; and (d) complete the transaction request by transmitting the transaction request over a wireless connection associated with the one or more user-designated trusted locations or the one or more user-designated trusted connections based at least partially on determining that the mobile device is located at the one or more user-designated trusted location or does have access to the one or more user-designated trusted connections for completing the mobile banking transaction, or store the transaction request in a queue for mobile banking transactions on the mobile device based at least partially on determining that the mobile device is not located at the one or more user-designated trusted locations or does not have access to one or more user-designated trusted connections for completing the mobile banking transaction.

In some embodiments of the computer program product, the determining whether the mobile device is located at one of the one or more user-designated trusted locations comprises: determining, using a position device, a location of the mobile device that received the transaction request; and comparing the determined location of the mobile device to the one or more user-designated trusted locations.

In some embodiments of the computer program product, the determining whether the mobile device has access to the one or more user-designated trusted connections comprises: using the mobile device to detect wireless connections or wireless networks accessible for use by the mobile device for completing the transaction request; and comparing the detected wireless connections or wireless networks to the one or more user-designated trusted connections.

In some embodiments of the computer program product, the one or more computer-executable program code portions, when executed by the computer, cause the computer to provide an alternate transaction request completion process for completing the transaction request, via the mobile device, based at least partially on determining that the mobile device is not at one of the one or more user-designated trusted locations or determining that the mobile device does not have access to one of the one or more user-designated trusted connections.

In some embodiments of the computer program product, the transaction request for the mobile banking transaction is a financial transaction including one or more of a fund transfer, a balance transfer, a checking an account balance, a bill payment, a financial account setup, an opening a new financial account, electronically depositing a check or negotiable instrument, and/or an ordering checks.

In some embodiments of the computer program product, the one or more computer-executable program code portions, when executed by the computer, cause the computer to receive, via the mobile device, one or more user-designated non-trusted locations and/or one or more user-designated non-trusted connections for not completing the transaction request for a mobile banking transaction and storing the transaction request based at least partially on determining that the mobile device is located at one of the one or more user-designated non-trusted locations or that the mobile device has access to one of the one or more user-designated non-trusted connections.

Brief Summary of Completing Mobile Banking Transaction With Different Devices

Some embodiments of the present invention provide a system for completing a mobile banking transaction using two or more devices: a mobile device; a storage device; and a module stored in the storage device, where the module comprises executable instructions that when executed by the processing device causes the processing device to: (a) initiate, via the mobile device, a transaction request for a mobile banking transaction; (b) store the transaction request for the mobile banking transaction in a queue for mobile banking transaction requests; (c) retrieve from the queue, using a computing device, the transaction request for the mobile banking transaction, wherein the computing device is different from the mobile device; and (d) complete, using the computing device, the transaction request for the mobile banking transaction.

In some embodiments of the system, the queue for mobile banking transaction requests is located in a centrally storage device accessible to the mobile device and computing device.

In some embodiments of the system, the queue is associated with one or more accounts involved in the transaction request for the mobile banking transaction.

In some embodiments of the system, the processing device is further configured to present a notification to the computing device of the transaction request being stored in the queue.

In some embodiments of the system, the notification to the computing device comprises a selectable feature that when selected by a user of the computing device initiates, on the computing device, a mobile banking application or an online banking application for completing the transaction request.

In some embodiments of the system, the processing device is further configured to: present, via the mobile device, one or more computing devices for completing the transaction request; receive, via the mobile device, a selection of one of the one or more computing devices for completing the transaction request; and provide a notification to the selected one of the one or more computing device, wherein the notification comprises information for completing the transaction request using the selected computing device.

In some embodiments of the system, the transaction request for the mobile banking transaction is a financial transaction including one or more of a fund transfer, a balance transfer, a checking an account balance, a bill payment, a financial account setup, an opening a new financial account, electronically depositing a check or negotiable instrument, and/or an ordering checks.

In some embodiments a computer-implemented method for completing a mobile banking transaction using two or more devices is provided that includes: providing a computer processor executing non-transitory computer-readable instruction code specifically structured to cause the computer processor to: (a) initiate, via a mobile device, a transaction request for a mobile banking transaction; (b) store the transaction request for the mobile banking transaction in a queue for mobile banking transaction requests; (c) retrieve from the queue, using a computing device, the transaction request for the mobile banking transaction, wherein the computing device is different from the mobile device; and (d) complete, using the computing device, the transaction request for the mobile banking transaction.

In some embodiments of the method, the queue for mobile banking transaction requests is located in a centrally storage device accessible to the mobile device and computing device.

In some embodiments of the method, the queue is associated with one or more accounts involved in the transaction request for the mobile banking transaction.

In some embodiments of the method, the computer processor is further executing computer-readable instruction code specifically configured to cause the computer processor to present a notification to the computing device of the transaction request being stored in the queue.

In some embodiments of the method, the notification to the computing device comprises a selectable feature that when selected by a user of the computing device initiates, on the computing device, a mobile banking application or an online banking application for completing the transaction request.

In some embodiments of the method, the computer processor is further executing computer-readable instruction code specifically configured to cause the computer processor to present, via the mobile device, one or more computing devices for completing the transaction request; receive, via the mobile device, a selection of one of the one or more computing devices for completing the transaction request; and provide a notification to the selected one of the one or more computing device, wherein the notification comprises information for completing the transaction request using the selected computing device.

In some embodiments of the method, the transaction request for the mobile banking transaction is a financial transaction including one or more of a fund transfer, a balance transfer, a checking an account balance, a bill payment, a financial account setup, an opening a new financial account, electronically depositing a check or negotiable instrument, and/or an ordering checks.

In some embodiments of the present invention a computer program product for completing a mobile banking transaction using two or more devices is provided that includes a non-transitory computer-readable medium, wherein the non-transitory computer-readable medium comprises one or more computer-executable program code portions that, when executed by a computer, cause the computer to: (a) initiate, via a mobile device, a transaction request for a mobile banking transaction; (b) store the transaction request for the mobile banking transaction in a queue for mobile banking transaction requests; (c) retrieve from the queue, using a computing device, the transaction request for the mobile banking transaction, wherein the computing device is different from the mobile device; and (d) complete, using the computing device, the transaction request for the mobile banking transaction.

In some embodiments of the computer program product, the queue for mobile banking transaction requests is located in a centrally storage device accessible to the mobile device and computing device.

In some embodiments of the computer program product, the queue is associated with one or more accounts involved in the transaction request for the mobile banking transaction.

In some embodiments of the computer program product, the one or more computer-executable program code portions, when executed by the computer, cause the computer to present a notification to the computing device of the transaction request being stored in the queue.

In some embodiments of the computer program product, the notification to the computing device comprises a selectable feature that when selected by a user of the computing device initiates, on the computing device, a mobile banking application or an online banking application for completing the transaction request.

In some embodiments of the computer program product, the one or more computer-executable program code portions, when executed by the computer, cause the computer to present, via the mobile device, one or more computing devices for completing the transaction request; receive, via the mobile device, a selection of one of the one or more computing devices for completing the transaction request; and provide a notification to the selected one of the one or more computing device, wherein the notification comprises information for completing the transaction request using the selected computing device.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a general process flow for completing a mobile banking transaction from a trusted location and/or trusted network, in accordance with some embodiments of the invention.

FIG. 2 is a block diagram illustrating an environment completing a mobile banking transaction from a trusted location and/or trusted network, in accordance with some embodiments of the invention.

FIG. 2A is a block diagram illustrating technical components of a mobile device configured to initiate and complete a proposed pending transaction, in accordance with an embodiment of the present invention.

FIG. 3 illustrates a general process flow for completing a mobile banking transaction using different devices, in accordance with some embodiments of the invention.

FIG. 4 is a block diagram illustrating an environment completing a mobile banking transaction using different devices, in accordance with some embodiments of the invention.

### DETAILED DESCRIPTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, and/or operational aspects of any of the embodiments described and/or contemplated herein may be included in any other embodiment of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout. Although the embodiments of the invention described herein are generally described as involving a “bank,” one of ordinary skill in the art will appreciate that other embodiments of the invention may involve other financial institutions, or businesses outside of financial institutions, that utilize customer representatives, call centers, or other comparable systems.

Embodiments of the present invention relate to a mobile banking application for determining whether a mobile device of a user is at a trusted location or is otherwise accessing or is using a trusted network. Using the mobile application, the user can input a transaction request into the mobile device. When it is determined that the mobile device is not located at a trusted location, the transaction request, input by the user, may be stored in a queue for processing at a later time when it is determined that the mobile device is in a trusted location. Upon determining that the mobile device is at a trusted location, the mobile banking application submits any transactions stored in the queue or otherwise to an appropriate entity, such as a financial institution, for additional processing or completing the transaction associated with the transaction request.

Generally, a “trusted location,” as used herein refers to a user-designated physical and/or virtual location that is reliable, safe, and/or is having one or more features or characteristics that the user deems useable for a given purpose. As an example, for the purpose of performing a financial transaction over a wireless network using a mobile device, a user may designate his home address/location, as a trusted location, where any wireless network(s) within that location can be used for performing the financial transaction.

Generally, a “trusted connection,” as used herein refers to a user-designated network and/or user-designated specifications of a wireless network that is reliable, safe, and/or is having one or more features or characteristics that the user deems useable for a given purpose. As an example, for the purpose of performing an online shopping transaction over a wireless network using a mobile device, a user may designate wireless connections having Wi-Fi Protected Access (WPA), as a minimum level of wireless network encryption, as a trusted connection for performing the online shopping transaction.

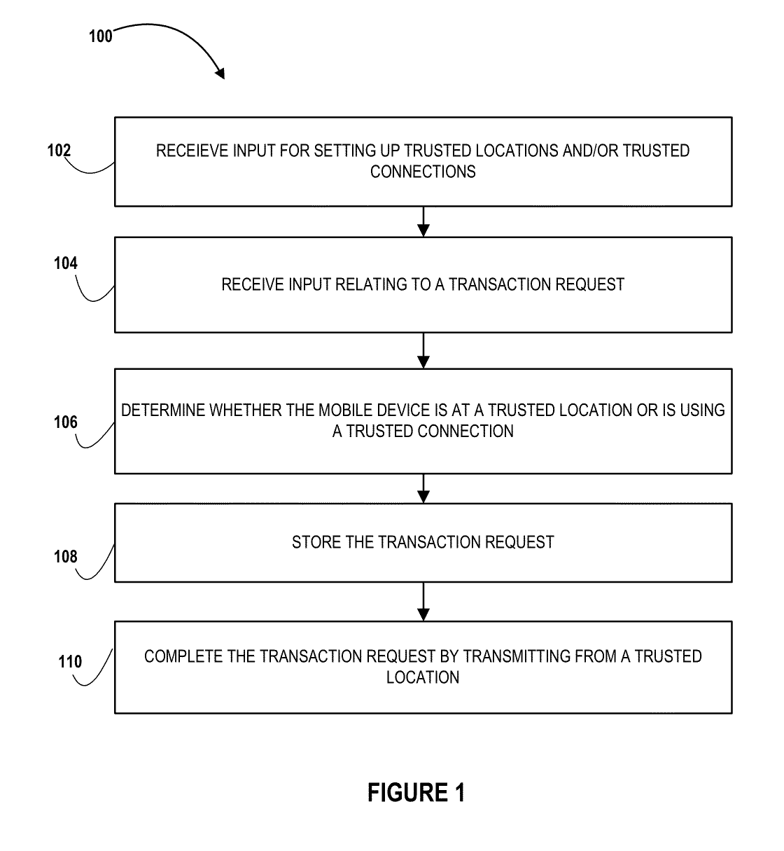

Referring now to FIG. 1, a general process flow 100 is provided for determining whether a mobile device of a user is at a trusted location or is using a trusted network for performing a transaction, in accordance with some embodiments of the present invention. In some embodiments, the process flow 100 is performed by a mobile device (i.e., one or more mobile device), where the mobile device has hardware and/or software configured to perform one or more portions of the process flow 100. In such embodiments, as represented by block 102, the mobile device is configured to receive input from a user associated with the mobile device for setting up one or more trusted locations and/or networks. As represented by block 104, the mobile device is also configured to receive input from the user relating to a transaction request. In addition, as represented by block 106, the mobile device is configured to determine whether the mobile device is at a trusted location or is using a trusted network for transmitting the transaction request. Further, at block 108, in some embodiments, when it is determined that the mobile device is not at a trusted location or using a trusted network, the mobile device stores the transaction request, as a proposed transaction request. Thereafter, as represented by block 110, the mobile device is configured to transmit the transaction request for processing.

Regarding process flow 100, the mobile device can include any number and/or type of mobile device(s). Examples of mobile devices include mobile phones (e.g., feature phones, smart phones, or the like), mobile gaming devices, mobile computers (e.g., tablet computers, laptop computers, or the like), personal digital assistants (PDAs), and/or the like. In some embodiments, the mobile device is configured to send and/or receive communications (e.g., phone calls, text messages, SMS messages, actionable alerts, emails, social media-specific messages, or the like), present information via a user interface, prompt a user of the mobile device to perform some action, play video games, browse the Internet, and/or the like. In some embodiments, the mobile device is portable (e.g., not stationary) and/or is carried and/or worn by and/or on a person (e.g., the user referred to in block 102). Additionally or alternatively, in some embodiments, the mobile device is controlled, serviced, owned, managed, operated, and/or maintained (collectively referred to herein as “maintained” for simplicity) by a person (e.g., the user) and/or by a financial institution.

Still regarding block 102, in some embodiments, the mobile device includes one or more near field communication (NFC) interfaces that are configured to communicate with one or more NFC interfaces associated with another computing device. For example, in some embodiments, the NFC interface of the mobile device can communicate transaction information (e.g., account names, routing numbers, account numbers, transaction amounts, etc.) directly with the NFC interface of the computing device. In some of these embodiments, the mobile device is configured to operate as a mobile wallet, meaning that the mobile device can be used to, for example, make payments, transfer transaction information, and/or otherwise engage in transactions at the computing device.

As used herein, the phrase “NFC interface” generally refers to hardware and/or software that is configured to contactlessly and/or wirelessly send and/or receive information over relatively short ranges (e.g., within four inches, within three feet, etc.). An NFC interface may include one or more transmitters, receivers, smart cards, key cards, proximity cards, radio frequency identification (RFID) tags and/or readers, and/or the like. In some embodiments, the NFC interface communicates information via radio, infrared (IR), and/or optical transmissions.

Continuing with block 102, once the user initiates the mobile banking application, the mobile device is configured to present a graphical user interface that provides one or more features, options, or input locations for setting up one or more trusted locations or user preferences for trusted networks for performing transactions with the mobile device. In some embodiments, the mobile application presents recommended locations that should be setup as trusted locations by the user. In such an embodiment, the mobile application may present via the user interface one or more selectable input features and/or input locations for receiving the one or more user-designated trusted locations or trusted networks. As an example, the mobile application may present a “Home” and an “Office” button, where each of the Home or Office button is selectable by the user for inputting his home address/location and his office address/location, as being trusted locations at which his mobile device may safely conduct transactions using the mobile banking application. It will be understood that the “Home” and “Office” buttons are just examples, and the mobile banking application may be configured to present several other buttons, such as a “School” button, “Coffee Shop” button, “Vacation” button, “Merchant Store” button, and/or the like. Once the user designates the one or more trusted locations, such as his home and/or office locations, this information is stored by the mobile device or a storage device associated with the mobile banking application for determining whether the mobile device is at a trusted location for performing a transaction using the mobile banking application. It will be understood that a user may be able to setup user-designated trusted locations using applications and/or computing devices other than the mobile banking application and/or mobile device. For example, the user may be able to setup trusted locations using a personal/desktop computer.

Still at block 102, in some embodiments, the user may specifically designate one or more wireless connections and/or wireless networks, as trusted connections, for performing transactions using the mobile banking application. As an example, the user may input, as a trusted connection, a router address of a router that provides a wireless connection and/or a name associated with a router providing a wireless connection into the setup portion of the mobile application. In such an example, the address or name information associated with the wireless router may be saved by the mobile banking application, such that when the address or name of the wireless router is detected by the mobile banking application, a transaction request by the user can be transmitted or completed without delay. It will be understood that a user may be able to setup user-designated trusted connections using applications and/or computing devices other than the mobile banking application and/or mobile device. For example, the user may be able to setup trusted locations using a personal/desktop computer.

In some embodiments, the user may specifically designate one or more trusted locations and/or one or more trusted connections for performing different types of transactions or transactions having a predetermined dollar amount. For example, a user may designate a first trusted location and/or location type for financial transactions using a mobile device that range from $0.01 to $500.00, a second trusted location and/or location type for financial transactions using a mobile device that range from $500.01 to $2000.00, and the like. As another example, a user may designate a first trusted connection and/or connection type for performing a transaction involving checking an account balance using a mobile device, a second trusted connection and/or connection type for financial transactions involving fund transfers, and the like. It will be understood that these are just examples and that a user may provide as input during the trusted location and/or trusted connection setup process any combination of the previously-mention and/or entirely different tiers, levels, or thresholds for performing transactions at certain trusted locations and/or trusted connections.

Still regarding block 102, in some embodiments, the mobile application is configured to present one or more recommendations of trusted locations and/or trusted connections, via the graphical user interface, based on transaction history or location history. In such an embodiment, the transaction history may include a history of transactions performed using a mobile device or otherwise, transaction history associated with an account that is further associated with the mobile banking application. The mobile banking application may use the transaction history to determine one or more merchant locations and/or networks to recommend as trusted locations and/or trusted connections. Also, in this embodiment, the location history may include the location history associated with a mobile device of the user, such that the mobile application may determine the most frequented locations of the user and recommend, as trusted locations and/or trusted connections, one or more of the most frequented locations and/or networks associated with the frequent locations.

Regarding block 102 further still, the mobile banking application may receive user input during the setup relating to one or more security requirements or specifications for a trusted connection. In such an embodiment, the user may provide details regarding one or more wireless connection types having one or more security features or specifications of which the user would consider a trusted connection. For example, the mobile application may receive user input indicating that any wireless connection that uses Hypertext Transfer Protocol Secure (HTTPS) as a communication protocol is a trusted connection for performing a transaction using the mobile banking application. It will be understood that this is just an example and the user may designate increased or lowered security requirements for a trusted connection relative to a HTTPS communication protocol.

In addition, in some embodiments, a user may also designate one or more non-trusted locations and/or one or more non-trusted connections. As an example, a user may specifically designate that when a transaction request is being attempted using a mobile device at public locations, such as a library, park, and/or the like, the mobile device is not to complete the transaction request and/or should place the transaction request in a proposed transaction request queue on the mobile device. Similarly, the user may designate that transaction request being attempted during certain hours during the day (e.g., 1:30 am-5:00 am eastern standard time) should not be completed by the mobile device. These unprocessed and/or completed transaction request may be stored in a proposed transaction queue for completion at a later time.

Regarding block 104, the user inputs relating to the transaction request may include and/or communicate any amount and/or type of information. In some embodiments, the user inputs include transaction information. In some embodiments, transaction is any information that identifies, defines, describes, and/or is otherwise associated with a proposed transaction request. Exemplary transaction information includes, but is not limited to, account numbers, account nicknames, tokens (e.g., transaction codes, nickname, software tokens, access tokens, information packages, data packets, widgets, transaction identifiers, etc.), the identity of the party(ies) involved in the proposed transaction request, the date and/or time that the proposed transaction is initiated and/or will be completed, the specific trusted connection that will be used to transmit the transaction request, how long the proposed transaction is valid and/or when the proposed transaction will expire, the account(s) involved in the proposed transaction, the status of the proposed transaction request (e.g., initiated, pending, authorized, completed, etc.), the transaction amount associated with the proposed transaction request, the description of the proposed transaction request (which, itself, can include any transaction information, e.g., the description may describe the transaction status, the transaction amount, the transaction type, etc.), and/or the like.

The transaction information can also include any information that defines and/or identifies the type of the proposed transaction request (e.g., cash withdrawal transaction, check deposit transaction, etc.). In some embodiments, the transaction type is defined, at least in part, by the one or more instruments and/or methods used to conduct the transaction, such as, for example, paper checks, electronic checks, debit cards, ATM cards, checkcards, wire transfers, online bill pay, automated clearing house (ACH), contactless payments, near field communication (NFC) interface payments, cash payments, and/or the like. Also, it will be understood that, for simplicity, the phrase “proposed transaction request” is sometimes used herein to mean “transaction information associated with the proposed transaction request,” and/or vice versa.

Still regarding block 104, the inputs may be input by the user of the mobile device in any way. For example, in some embodiments, the mobile device includes a keyboard, microphone, and/or one or more other user input devices for inputting the one or more user inputs. As another example, in some embodiments, the mobile device presents, via a touchscreen display of the mobile device, one or more fields, buttons, drop-down menus, and/or other user interface features that enable the customer to input and/or communicate information to the mobile device. In some embodiments, the user actually enters account numbers, transaction amounts, payee names, and/or other information into the mobile device, whereas, in other embodiments, the user communicates information to the mobile device by selecting buttons and/or other user interface features that are provided to the user by the mobile device.

Now, regarding block 106, based at least partially on a determined geo-location of the mobile device, the mobile device determines whether or not it is at a trusted location. In such an embodiment, the mobile device using a positioning system or component determines its geographic location. Then the mobile device compares and/or matches its determined location to the one or more trusted locations designated by the user. If during the comparing, the mobile device determines a match between its location and the one or more trusted location designated by the user, the mobile device scans for useable networks in the proximity of the trusted location for processing and/or completion of the proposed transaction request by transmitting the transaction information associated with the transaction request over the network. As an example, a user may create a proposed transaction request using a mobile device. In such an example, once the proposed transaction is created or contemporaneously with the creation of the proposed transaction, the mobile device determines that the physical location of the mobile device is at a home location of the user. The mobile device may then compare the home location of the user to the one or more user-designated trusted locations. In this example, the mobile device determines a successful match and then continues to process the proposed transaction over a wireless network associated with the home location.

In some embodiments, when the mobile device has determined that there is a match in the geo-location of the mobile device and two or more networks associated with the user-designated trusted location with a match, the system may prompt the user to choose which of the two or more networks the user would prefer to use for performing the proposed transaction request. For example, when a match is determined between the physical location of the mobile device and the office location of the user, there may be two or more local network connections associated with the office location that can be used for transmitting a proposed transaction request for completion. In such an example, the user is presented with the two or more options of useable networks that are at the office location, so that the mobile device may receive a selection from the user of one of the two or more networks for transmitting and/or completing the proposed transaction request.

Still regarding block 106, in some embodiments, the mobile device determines a trusted connection based at least partially on one or more features or characteristics of the networks that are accessible to the mobile device. In such an embodiment, the mobile device determines a trusted connection based on comparing the one or more features of the networks accessible to the mobile device to user-designated one or more features and/or characteristics of a trusted connection. For example, the user may designate that only the wireless connections having a minimum of Wi-Fi Protected Access (WPA) level of encryption may be used for completing a transaction request when using the mobile device. In such an example, the mobile device may scan for all available wireless connections that are accessible to the mobile device meeting the minimum WPA requirement. More particularly, a mobile banking application on the mobile device scans the wireless connections that are accessible to the mobile device and determines security protocols associated with each of the wireless connections. The mobile device using the mobile banking application may then compare the security protocols of each of the wireless connections to the user-designated minimum security protocols for a trusted connection. Upon determining one or more successful matches among the wireless connections, the mobile device is configured present to the user the one or more successful matches, such that the user can select one for transmitting/completing the transaction request. In the instance that there is more than one, the mobile device is configured to present to the user the two or more wireless connections meeting the minimum WPA requirement for completing the transaction request.

In some embodiments, when the mobile device determines that it is not at a trusted location and/or there are no trusted connections available for completing the transaction request, the mobile device using the mobile banking application may provide a default transaction request authorization and/or completion method. The mobile device, in such embodiments, may require that the user provide additional authentication information for allowing the transaction request to be completed. Examples of the additional authentications that may be required from the user may include, but is not limited to, entering successful pin codes, successful answer to a challenge question, speaking to an agent, and/or the like. It will be understood that the default authentication procedures when a trusted location and/or trusted connection is not found may include various other procedures and should not be limited to the previously-mentioned examples.

Further regarding block 108, the phrase “proposed transaction request” generally refers to financial transaction or the like that has been initiated but not yet completed. For example, a proposed transaction request may include a fund transfer, where the details for successfully executing the fund transfer are provided in the transaction requests, such once the fund transfer is submitted or transmitted no additional input is required from the user making the transaction. In such an example, the details of the transaction request may include a first account from which funds are being transferred, a second account to which the funds will be transferred to, a fund amount or value, a fund transfer time and/or date, and/or the like. It will be understood that a proposed transaction request can include any number and/or type of transaction(s) involving a financial account or the like. For example, in some embodiments, the proposed transaction request referred to in block 108 is for: withdrawing cash; depositing cash and/or checks; checking account balances; making payments to creditors (e.g., paying monthly bills; paying federal, state, and/or local taxes and/or bills; etc.); sending remittances; transferring balances from one account to another account; loading money onto stored value cards; donating to charities; and/or the like.

In some embodiments, the proposed transaction request involves an account, and in some embodiments, that account is held by the user referred to in block 102. For example, in some embodiments, the proposed transaction request involves an account held by the user because the proposed transaction request includes a fund transfer from the account held by the user. It will be understood that the account involved in the proposed transaction request can include any number and/or type of account(s). For example, in some embodiments, the account includes a checking account, credit account, savings account, money market account, investment account, brokerage account, certificate of deposit account, and/or any other type of deposit account.

As represented by block 108, the mobile device can be configured to store the transaction request on the mobile device in any way based at least partially on determining that the mobile device having the transaction request is not at a trusted location or is not using a trusted connection. In some embodiments, the mobile device can also be configured to store the transaction request with a remote storage device associated with the mobile banking application. In some embodiments, the transaction information associated with the transaction request is stored in the memory of the mobile device. This memory may be non-temporary, non-volatile, and/or long-term persistent memory, but in some embodiments, in addition to or instead of storing the transaction information in non-temporary, non-volatile, and/or long-term persistent memory, the mobile device stores the transaction information in temporary and/or volatile memory. It will be understood that, in some embodiments, the transaction information is stored on the mobile device until it is determined that the mobile device is at a trusted location for transmitting the transaction information and/or completing the transaction request over a wireless connection and/or network.

In some embodiments, the mobile device is configured to store the transaction information in a proposed transaction request queue on the mobile device. In some embodiments, this queue is stored in the memory of the mobile device. As a specific example, in some embodiments, the mobile device is configured to generate a token associated with the proposed transaction request (e.g., information packages having information associated with the proposed transaction request therein, a transaction code, a transaction identifier, etc.) and then place that token into the proposed transaction request queue. In some embodiments, the token is presented, via a user interface of the mobile device, to the user of the mobile device, such that the user may determine and/or view which proposed transaction request are stored in the queue. In addition, after determining that the mobile device is at a trusted location or is using a trusted connection, the token may be transferred from the proposed transaction request queue of the mobile device directly to a financial institution, such that the financial institution can complete the proposed transaction request based at least partially on the token. In some embodiments, the token is readable and/or executable by a server and/or a computer associated with the financial institution, even though, in some embodiments, the token is not readable to, and/or viewable by, the user of the mobile device. In some embodiments, the token is removed, deleted, and/or erased from the proposed transaction request queue after the proposed transaction request is completed by the financial institution and/or after the token is transferred to the financial institution over a trusted connection and/or from the trusted location. Also, it will be understood that the proposed transaction request queue described and/or contemplated herein may be organized and/or viewable to the user of the mobile device as a list, table, dashboard, transaction ledger, and/or in some other format. Further, in accordance with some embodiments, proposed transaction request may be stored in the proposed transaction request queue in the order they were initiated.

In some embodiments, the proposed transaction request remains pending for at least one minute, two minutes, one hour, three days, one month, and/or some other non-trivial and/or appreciable period of time before being completed. In some embodiments, the proposed transaction request remains pending on the mobile device until deleted and/or removed from the mobile device by the user. In some embodiments, the proposed transaction request is only valid for a predetermined period of time. In other words, in some embodiments, the proposed transaction request may expire. For example, in some embodiments, a proposed transaction request is only valid for, and/or will expire after, five minutes, two hours, one day, etc. after being initiated and/or stored on the mobile device (and/or in a proposed transaction request queue). In such embodiments, if it is not determined that the mobile device is at a trusted location or is using a trusted connection within that period of time, then the proposed transaction request (and/or transaction information associated therewith) may be removed, erased, and/or deleted from the mobile device. In some embodiments, the user can select (e.g., via the one or more inputs) when the proposed transaction request is to expire and/or for how long the proposed transaction request is to remain valid.

Additionally, in some embodiments, upon storing or contemporaneously with storing the proposed transaction request, the system is configured to receive a request from the user to provide an alert to remind the user that the proposed transaction request is pending in the transaction request queue. In some embodiments, the system is configured to provide the alert request to an online banking account associated with the user, such that the online banking account can periodically or continually scan for the presence of the mobile device being at a trusted location and/or using a trusted connection. Once the online banking account determines that the mobile device is at a trusted location, the online banking account may automatically trigger the transmission of the proposed transaction request for completion.

Regarding block 110, the phrase “transmit the transaction request” is meant to be understood in its broadest sense. Thus, in some embodiments, the mobile device is configured to send the transaction information associated with the transaction request from the mobile device over a trusted connection and/or from the trusted location to the financial institution, whereas, in other embodiments, the financial institution is configured to retrieve the transaction information from the mobile device. It will be understood that the financial institution processes and/or completed the proposed transaction request when the financial institution performs one or more meaningful actions relevant to the transaction request, such as, for example, transferring funds, presenting an account balance, performing an online bill pay, and/or the like. Also, in some embodiments, the financial institution is configured to complete the proposed transaction request automatically after the financial institution receives the transaction information from the mobile device, such that the transaction request is completed without any additional action by the user. In addition, in some embodiments, the mobile device is configured to automatically (without human interaction) transmit the transaction request for completion when the mobile determines that the mobile device is in a trusted location and/or is using a trusted connection and/or has access to a trusted connection. In this way, when the transaction request is pending in the transaction request queue, the user does not have to take any active steps for completing the transaction upon arriving at a trusted location and/or upon gaining access to a trusted connection.

Still regarding block 110, in some embodiments, a device or network other than the mobile device is configured to determine that the user is at a trusted location, using a trusted network, or at a trusted computing device and automatically transmit the transaction request. For example, in some embodiments, a user's home network is a trusted connection that is configured to determine that the user has one or more pending proposed transaction request that was initiated using a mobile device of the user. In such an example, when the user arrives to or is at the home network, the network will detect the mobile device of the user and automatically transmit the proposed transaction request over the home network. In this way, the home network is configured to detect whether the mobile device is at a trusted location or using a trusted connection in addition to or in lieu of the mobile device determining its own location.

Similarly, a computing device, such as a desktop computer, may be able to detect the presence of the user or determine the location of the user for automatically transmitting the proposed transaction request stored in a queue of the mobile device. As an example, a desktop computer of a user may detect that the user has one or more proposed transactions stored on his mobile device and further detect that the mobile device is at a trusted location and/or using a trusted connection. In such an example, the desktop computer may communicate with the mobile device so that the proposed transaction requests may be transmitted over a network on which the desktop computer is operating.

Additionally, in some embodiments, an online account and/or an online banking account is configured to determine that a user is at a trusted location and/or using a trusted connection and that one or more proposed transaction request stored and pending transmission. In such an embodiment, the online banking account may be continually attempting to pair its trusted network to a mobile device of a user in order to determine whether there are one or more proposed transaction requests in the queue of the mobile device. Once the online banking account successfully pairs with the mobile device, the online banking account may either retrieve the proposed transactions from the queue of the mobile device for completion or simply prompt the mobile device to transmit the one or more proposed transactions over a network associated with the online banking account.

The mobile device that is configured to perform the process flow 100 can be configured to perform any of the portions of the process flow 100 represented by blocks 102-110 upon or after one or more triggering events (which, in some embodiments, is one or more of the other portions of the process flow 100). As used herein, a “triggering event” refers to an event that automatically (i.e., without human intervention) triggers the execution, performance, and/or implementation of a triggered action, either immediately, nearly immediately, or sometime after (e.g., within minutes, etc.) the occurrence of the triggering event. For example, in some embodiments, the mobile device is configured such that the mobile device determining that the mobile device is at a trusted location (the triggering event) automatically and immediately or nearly immediately triggers the mobile device to transmit to a financial institution the transaction request over a wireless communication network associated with the trusted location (the triggered action(s)). As another example, in some embodiments, when the mobile device determines that the mobile device is not at a trusted location (the triggering event) automatically and immediately or near immediately triggers the mobile device to store the transaction request in a proposed transaction request queue (triggered action).

In some embodiments, the mobile device is configured to automatically perform one or more of the portions of the process flow 100 represented by blocks 102-110, whereas in other embodiments, one or more of the portions of the process flow 100 represented by blocks 102-110 require and/or involve human action (e.g., a user may operate the mobile to perform one or more portions of the process flow 100). In addition, it will be understood that, in some embodiments, the mobile device (and/or the user thereof) is configured to perform one or more portions (or combinations of portions) of the process flow 100, from start to finish, within moments, seconds, and/or minutes (e.g., within approximately 1-15 minutes from start to finish, etc.) or otherwise, in substantially real-time, as portions of the process flow 102-110 are occurring. It will be further understood that the number, order, and/or content of the portions of process flow 100 are exemplary and may vary.

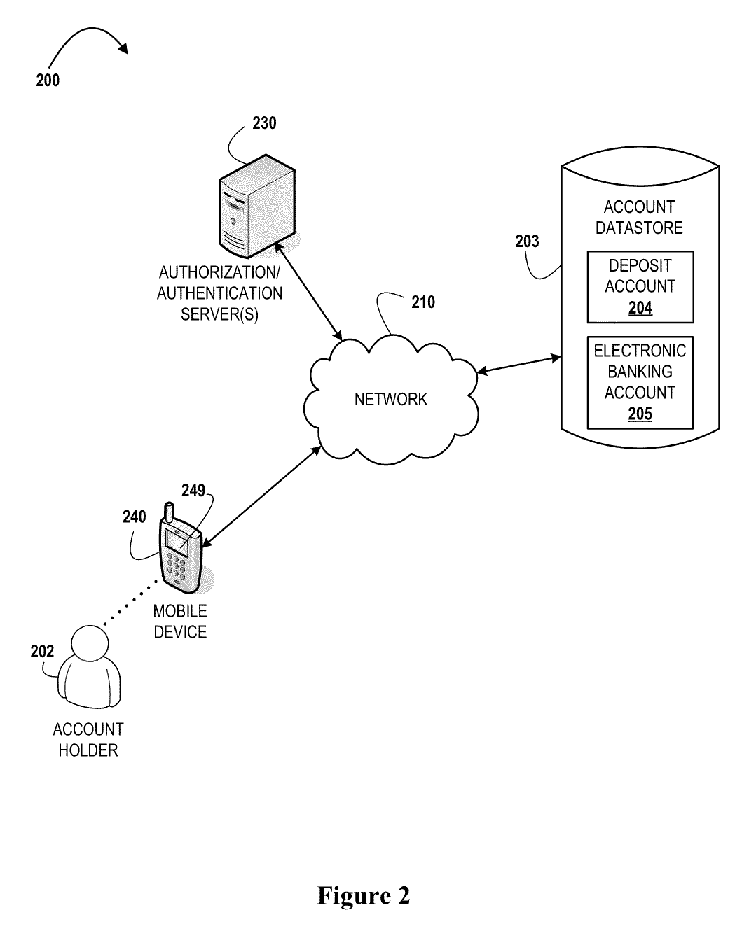

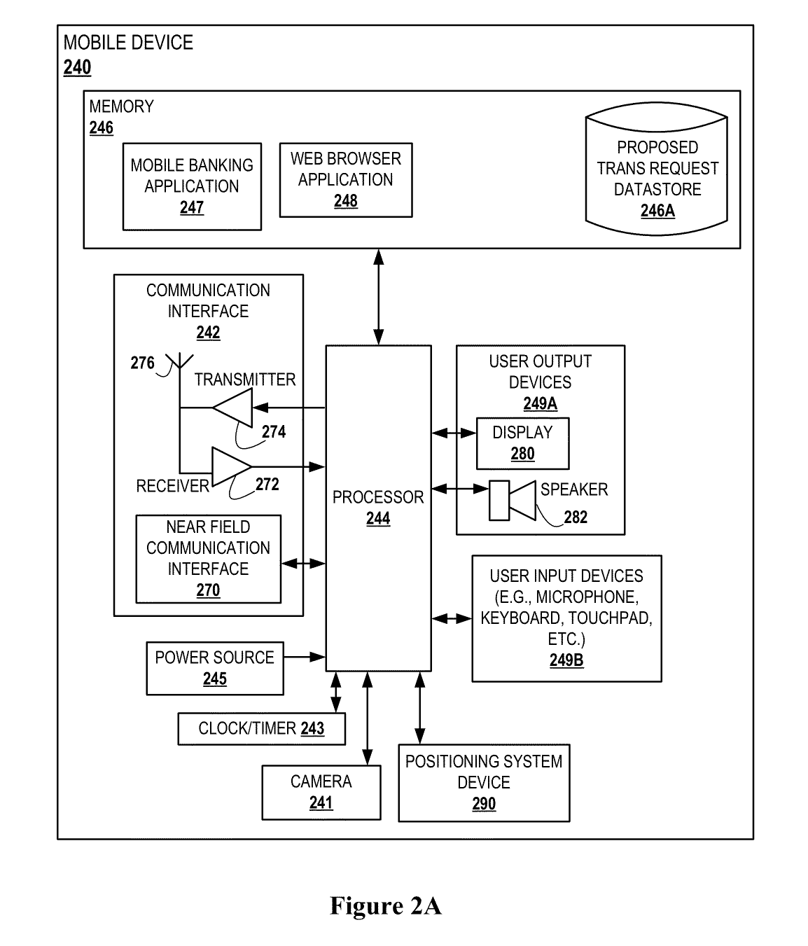

Referring now to FIG. 2, a system 200 for initiating and completing proposed transaction requests using a trusted network is provided, in accordance with an embodiment of the present invention. As illustrated, the system 200 includes a network 210, one or more financial institution servers 230, an account datastore 203, and a mobile device 240. As shown, the account datastore 203 includes a deposit account 204 and an electronic banking account 205. In this example embodiment, the deposit account 204 (e.g., checking account, savings account, investment account, etc.) is associated with the electronic banking account 205 (e.g., online banking account, mobile banking account, etc.). FIG. 2 also shows the account holder 202, who holds the deposit account 204 and has access to the mobile device 240. In accordance with some embodiments, a single bank maintains the account datastore 203 and the authorization server 230. In such embodiments, the holder 202 is a customer of the bank. Also, in accordance with some embodiments, the mobile device 240 is associated with the holder 202, and/or is carried, operated, controlled, possessed, and/or owned by the holder 202.

As shown in FIG. 2, the authorization server 230 and the mobile device 240 are each operatively and selectively connected to the network 210, which may include one or more separate networks. The network 210 may include one or more interbank networks, telephone networks, telecommunication networks, cellular networks, NFC networks, local area networks (LANs), wide area networks (WANs), and/or global area networks (GANs) (e.g., the Internet, etc.). It will also be understood that the network 210 may be secure and/or unsecure and may also include wireless and/or wireline technology. Also, as shown in FIG. 2, the mobile device 240 is directly, selectively, and/or operatively connected to the server 230 via one or more wireline and/or wireless connections.

Each communication interface described herein, including the communication interface 242, generally includes hardware, and, in some instances, software, that enables a portion of the system 200, such as the mobile device 240, to send, receive, and/or otherwise communicate information to and/or from the communication interface of one or more other portions of the system 200. Each communication interface described herein can include a modem, network interface controller (NIC), NFC interface, network adapter, network interface card, transceiver, antenna, transmitter, receiver, and/or some other electronic communication device that operatively connects one apparatus to another.

Each processor described herein, including the processor 244, generally includes circuitry for implementing the audio, visual, and/or logic functions of that portion of the system 200. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the mobile banking application 247 of the memory 246 of the mobile device 240.

Each memory device described herein, including the memory 246 for storing the mobile banking application 247 and other information, may include any computer-readable medium. For example, the memory may include temporary and/or volatile memory, such as volatile random access memory (RAM) having a cache area for the temporary storage of data. Memory may also include non-temporary, non-volatile, and/or long-term persistent memory, which may be embedded and/or may be removable. The non-volatile memory may additionally or alternatively include an EEPROM, flash memory, and/or the like. The memory may store any one or more of portions of information used by the apparatus in which it resides to implement the functions of that apparatus.

Each user interface described herein, including the user interface 249, generally includes one or more user output devices for presenting information and/or one or more items to a user (e.g., the holder 202, etc.), such as, for example, one or more displays, speakers, receipt printers, dispensers (e.g., cash dispensers, ticket dispensers, merchandise dispensers, etc.), and/or the like. In some embodiments, the user interface additionally or alternatively includes one or more user input devices, such as, for example, one or more buttons, keys, dials, levers, directional pads, joysticks, keyboards, mouses, accelerometers, controllers, microphones, touchpads, touchscreens, haptic interfaces, scanners, biometric readers, motion detectors, cameras, card readers (e.g., for reading the magnetic strip on magnetic cards such as ATM, debit, credit, and/or bank cards, etc.), deposit mechanisms (e.g., for depositing checks and/or cash, etc.), and/or the like for receiving information from one or more items and/or from the user (e.g., the holder 202, etc.).

Each datastore described herein, including the proposed transaction request datastore 246, and the account datastore 203, can be configured to store any type and/or amount of information. For example, in some embodiments, the proposed transaction request datastore 246 is configured to store transaction information associated with one or more proposed transaction request. In some embodiments, the proposed transaction request datastore 246 include one or more queues, lists, tables, dashboards, ledgers, etc. for organizing, displaying, and/or storing one or more proposed transaction requests. The datastores may include any one or more storage devices, including, but not limited to, datastores, databases, and/or any of the other storage devices typically associated with a mobile device, server, and/or computer system. It will also be understood that the datastores may store information in any known way, such as, for example, by using one or more computer codes and/or languages, alphanumeric character strings, data sets, figures, tables, charts, links, documents, and/or the like. Further, in some embodiments, the datastores include information associated with one or more applications, such as, for example, the mobile banking application 247. In some embodiments, each datastore provides a real-time or near real-time representation of the information stored therein, so that, for example, when a processor accesses that datastore, the information stored therein is current or nearly current.

Referring now to FIG. 2A, a block diagram is provided that illustrates the mobile device 240 of FIG. 2 in more detail, in accordance with an embodiment of the present invention. In some embodiments, the mobile device 240 is a mobile phone, but in other embodiments, the mobile device 240 can include and/or be embodied as any other mobile device described and/or contemplated herein. The mobile device 240 can be configured to initiate, perform, transmit, complete, and/or facilitate any portion of any embodiment described and/or contemplated herein as being initiated, performed, completed, and/or facilitated by a mobile device. As shown in FIG. 2A, the mobile device 240 includes a processor 244 operatively connected to memory 246, user output devices 249A, user input devices 249B, a communication interface 242, a power source 245, a clock or other timer 243, a camera 241, and a positioning system device 290.

The processor 244 may include the functionality to encode and interleave messages and data prior to modulation and transmission. The processor 244 can additionally include an internal data modem. Further, the processor 244 may include functionality to operate one or more software programs, which may be stored in the memory 246. For example, the processor 244 may be capable of operating a connectivity program, such as a web browser application 248. The web browser application 248 may then allow the mobile device 240 to transmit and receive web content, such as, for example, location-based content and/or other web page content, according to a Wireless Application Protocol (WAP), Hypertext Transfer Protocol (HTTP), and/or the like.

The processor 244 is configured to use the communication interface 242 to communicate with one or more other devices on the network 310. In this regard, the communication interface 242 includes an antenna 276 operatively coupled to a transmitter 274 and a receiver 272 (together a “transceiver”). The processor 244 is configured to provide signals to and receive signals from the transmitter 274 and receiver 272, respectively. The signals may include signaling information in accordance with the air interface standard of the applicable cellular system of the wireless telephone network 210. In this regard, the mobile device 240 may be configured to operate with one or more air interface standards, communication protocols, modulation types, and access types. By way of illustration, the mobile device 240 may be configured to operate in accordance with any of a number of first, second, third, and/or fourth-generation communication protocols and/or the like. For example, the mobile device 240 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 240 may also be configured to operate in accordance with non-cellular communication mechanisms, such as via a wireless local area network (WLAN) or other communication/data networks.

The communication interface 242 of the mobile device 240 may also include an NFC interface 270. The NFC interface 270 is configured to contactlessly and/or wirelessly send and/or receive information over relatively short ranges (e.g., within four inches, within three feet, etc.). The NFC interface 270 may include a transmitter, receiver, smart card, key card, proximity card, radio frequency identification (RFID) tag and/or reader, and/or the like. In some embodiments, the NFC interface 270 communicates information via radio, IR, and/or optical transmissions. In some embodiments, the NFC interface 270 is configured to operate as an NFC transmitter and/or as an NFC receiver (e.g., an NFC reader, etc.). In some embodiments, the NFC interface 270 enables the mobile device 240 to operate as a mobile wallet. Also, it will be understood that the NFC interface 270 may be embedded, built, carried, and/or otherwise supported in and/or on the mobile device 240. In some embodiments, the NFC interface 270 is not supported in and/or on the mobile device 240, but the NFC interface 270 is otherwise operatively connected to the mobile device 240 (e.g., where the NFC interface 270 is a peripheral device plugged into the mobile device 240, etc.). Other apparatuses having NFC interfaces mentioned herein may be configured similarly.

In some embodiments, the NFC interface 270 of the mobile device 240 is configured to contactlessly and/or wirelessly communicate information to and/or from a corresponding NFC interface of another apparatus. For example, in some embodiments, the mobile device 240 is a mobile phone, the NFC interface 270 is a smart card having transaction information associated with proposed transaction requests stored therein. In such embodiments, when the mobile phone and/or smart card is brought within a relatively short range of the NFC reader, the smart card is configured to wirelessly and/or contactlessly send the transaction information to the NFC reader in order to complete the proposed transaction request(s).

In addition to the NFC interface 270, the mobile device 240 can have a user interface 249 that is, like other user interfaces described herein, made up of one or more user output devices 249A and/or user input devices 249B. The user output devices 249A include a display 280 (e.g., a liquid crystal display, a touchscreen display, and/or the like) and a speaker 282 and/or other audio device, which are operatively coupled to the processor 244. The user input devices 249B, which allow the mobile device 240 to receive data from a user such as the holder 302, may include any of a number of devices allowing the mobile device 240 to receive data from a user, such as a keypad, keyboard, touch-screen, touchpad, microphone, mouse, joystick, other pointer device, button, soft key, and/or other input device(s). The user interface 249 may also include a camera 241, such as a digital camera.

In some embodiments, the mobile device 240 also includes a positioning system device 290 that can be used to determine the location of the mobile device 240. For example, the positioning system device 290 may include a GPS transceiver. In some embodiments, the positioning system device 290 is at least partially made up of the antenna 276, transmitter 274, and receiver 272 described above. For example, in one embodiment, triangulation of cellular signals may be used to identify the approximate location of the mobile device 240. In other embodiments, the positioning system device 290 includes a proximity sensor and/or transmitter, such as an RFID tag, that can sense or be sensed by devices known to be located proximate an ATM and/or other locations to determine that the mobile device 240 is located proximate these known devices.

The mobile device 240 further includes a power source 245, such as a battery, for powering various circuits and other devices that are used to operate the mobile device 240. Embodiments of the mobile device 240 may also include a clock or other timer 243 configured to determine and, in some cases, communicate actual or relative time to the processor 244 or one or more other devices.

The mobile device 240 also includes a memory 246 operatively connected to the processor 244. The memory 246 can store any of a number of applications which may include computer-executable program code executed by the processor 244 to implement the functions of the mobile device 240 described herein. For example, the memory 246 may include such applications as a web browser application 248 and/or a mobile banking application 247. It will be understood that the web browser application 248 and/or the mobile banking application 247 can be, individually or collectively, operable to initiate, perform, complete, and/or facilitate one or more portions of any embodiment described and/or contemplated herein, such as, for example, any one or more portions of the process flows 100 and/or 300 described herein.

For example, in some embodiments, the mobile banking application 247 is executable to authenticate the holder 202. As another example, in some embodiments, the mobile banking application 247 is executable to prompt (e.g., via the user interface 249) the holder 202 to input, into the mobile device 240, information for initiating one or more proposed transaction requests. As still another example, in some embodiments, the mobile banking application 247 is executable to initiate one or more proposed transaction requests. As another example, in some embodiments, the mobile banking application 247 is executable to store transaction information associated with one or more proposed transaction requests in the proposed transaction request datastore 246A and/or elsewhere in the memory 246. As another example, in some embodiments, the mobile banking application 247 is executable to store authentication information associated with one or more proposed transaction requests in the proposed transaction request datastore 246A. As still another example, in some embodiments, the mobile banking application 247 is executable to present information associated with one or more proposed transaction requests to the holder 202 and/or to prompt the holder to select one or more of the presented proposed transaction requests for transfer (e.g., to the server 230). As another example, in some embodiments, the mobile banking application 247 is executable to transfer transaction information associated with the one or more proposed transaction requests directly and/or indirectly between the mobile device 240 and the server 230.

In some embodiments, the mobile banking application 247 and/or the web browser application 248 is executable to enable the holder 202 and/or mobile device 240 to communicate with one or more other portions of the system 200, and/or vice versa. In some embodiments, the mobile banking application 247 and/or the web browser application 248 is additionally or alternatively executable to initiate, perform, complete, and/or otherwise facilitate one or more financial and/or non-financial transactions. In some embodiments, the mobile banking application 247 and/or the web browser application 248 includes one or more computer-executable program code portions for causing and/or instructing the processor 244 to perform one or more of the functions of the mobile banking application 247, web browser application 248, and/or mobile device 240 described and/or contemplated herein. In some embodiments, the mobile banking application 247 and/or the web browser application 248 includes and/or uses one or more network and/or system communication protocols.

In some embodiments, the mobile banking application 247 and/or the web browser application 248 are executable to render and/or otherwise provide a graphical user interface on the display 280 that allows the holder 202 to communicate with the mobile device 240, the authorization server 230, and/or one or more other portions of the system 200. In some embodiments, the holder 202 can use the mobile banking application 247 and/or the web browser application 248 to access the electronic banking account 209 (e.g., mobile banking account, etc.) that is associated with the deposit account 204. The memory 246 can also store any type and/or amount information used by the mobile device 240, and/or used by the applications and/or the devices that make up the mobile device 240 and/or that are in communication with the mobile device 240, to implement the functions of the mobile device 240 and/or the other systems described and/or contemplated herein. For example, in some embodiments, the memory 246 stores account information (e.g., routing and/or account numbers, account names, etc.), authentication information (e.g., username/passwords, PINs, tokens, biometric information, etc.) associated with one or more proposed transaction requests, and/or transaction information associated with one or more proposed transaction requests in the memory 246, which can include the pending ATM transaction datastore 246A.

FIG. 2 also illustrates authorization/authentication server(s) 230, in accordance with some embodiments of the present invention. The authorization/authentication server 230 can include any server and/or apparatus described and/or contemplated herein. Additionally or alternatively, the server 230 can be configured to initiate, perform, complete, and/or facilitate any portion of any embodiment described and/or contemplated herein as being initiated, performed, completed, and/or facilitated by a server and/or apparatus. In some embodiments, the server 230 includes one or more servers, engines, mainframes, personal computers, ATMs, network devices, front end systems, back end systems, and/or the like. It will be understood that the server 230 may include a communication interface, a processor, and a memory, which may include one or more applications and/or datastores.

In some embodiments, the server 230 is configured (and/or an application thereof is executable) to receive transaction information associated with one or more proposed transaction requests and/or authorize those one or more proposed transaction requests for completion. In some embodiments, the server 230 is configured (and/or an application thereof is executable) to receive authentication information associated with one or more proposed transaction requests and/or authorize those one or more proposed transaction requests for completion. In some embodiments, the server 230 is configured to receive, approve, and/or decline one or more authorization and/or authentication requests, including those for completing one or more proposed transaction requests. Additionally or alternatively, in some embodiments, the server 230 is configured to determine that the mobile device 240 is authorized by the holder 302 to initiate and/or transfer proposed transaction requests and/or to determine that the mobile device 240 is otherwise in a trusted location/using a trusted connection and is associated with the holder 302 and/or the account 304.

In some embodiments, the server 230 is configured to: (a) receive, from the mobile device 240, information associated with one or more inputs, where the one or more inputs were inputted into the mobile device 240 by the holder 202; (b) generate transaction information and/or authentication information based at least partially on the information associated with the one or more inputs (e.g., generate one or more tokens having information associated with the one or more inputs stored therein, etc.); and (c) send the transaction information and/or the authentication information (e.g., the one or more tokens) to the mobile device 240, so that the mobile device 240 can transfer the transaction information and/or the authentication information (e.g., the one or more tokens) to another mobile device and/or consumer computing device for completing one or more proposed transaction requests.

In some embodiments, the server 230 is configured to communicate with one or more other portions of the system 200, such as, for example, a datastore included in the authorization server 230, the mobile device 240, and/or vice versa. Also, in some embodiments, the server 230 includes one or more applications, where those one or more applications include one or more computer-executable program code portions for causing and/or instructing the processor of the server 230 to perform one or more of the functions of the server 230 described and/or contemplated herein. In some embodiments, the server 230 includes and/or uses one or more network and/or system communication protocols.

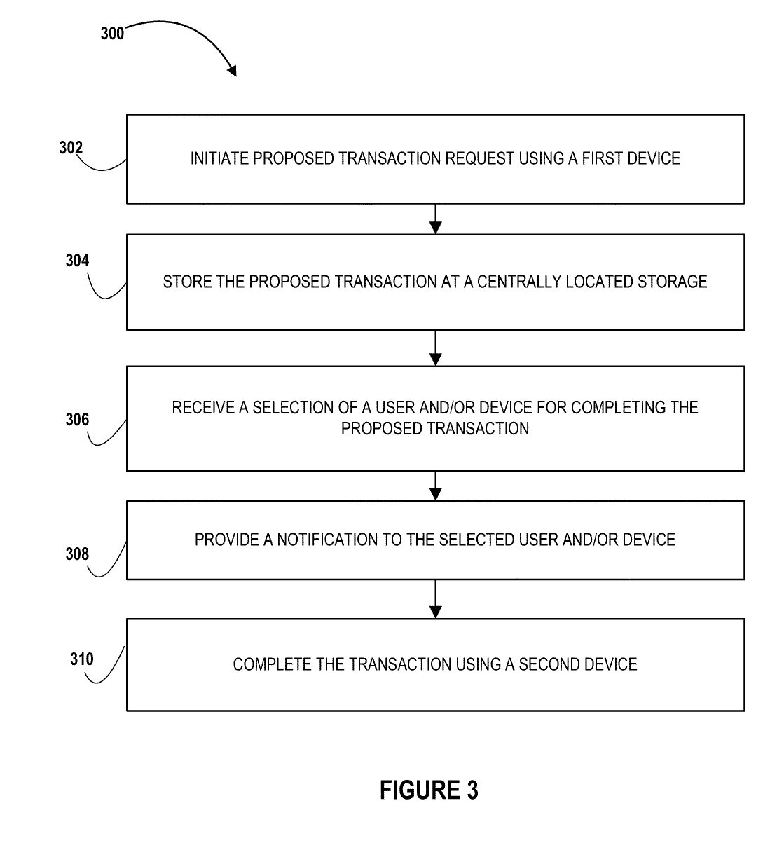

It will be understood that the embodiments illustrated in FIGS. 3 and 3A are exemplary and that other embodiments may vary. For example, in some embodiments, some or all of the portions of the system 200 are combined into a single portion. Specifically, in some embodiments, the datastore 203 and the server 230 are combined into a single datastore and authorization apparatus that is configured to perform all of the same functions of those separate portions as described and/or contemplated herein. Likewise, in some embodiments, some or all of the portions of the system 200 are separated into two or more distinct portions. In addition, the various portions of the system 200 may be maintained by the same or separate parties.

It will be understood that the system 200 and/or one or more portions of the system 200 may include and/or implement any embodiment of the present invention described and/or contemplated herein. For example, in some embodiments, the system 200 (and/or one or more portions of the system 200) is configured to implement any one or more embodiments of the process flow 100 described and/or contemplated herein in connection with FIG. 1 and any one or more embodiments of the process flow 300 described and/or contemplated herein in connection with FIG. 3.

Completing Mobile Banking Transaction With Different Devices

Embodiments of the present invention relate to a mobile banking application for allowing a user of the mobile banking application to complete a mobile banking transaction using multiple devices. The user can store the partially completed mobile banking transaction in a centrally located transaction queue. In many instances, the centrally location transaction queue is accessible to multiple other consumer devices other than the mobile device that initiated the mobile banking transactions stored in the transaction queue. Using the mobile application, the user can provide a notification to another user and/or another consumer device (e.g., mobile phone, tablet, and/or the like) for completing the pending mobile banking transaction request. Upon receiving the notification, the another consumer device can be used to retrieve the transaction request from the centrally located transaction queue and complete the transaction request.

Referring now to FIG. 3, a general process flow 300 is provided for completing a mobile banking transaction with different devices, in accordance with an embodiment of the present invention. In some embodiments, the process flow 300 is performed, in combination, by a first mobile device and a second mobile device and/or another computing device, where each have hardware and/or software configured to perform one or more portions of process flow 300. In such embodiments, as represented by block 302, the mobile device is configured to initiate a proposed transaction request on the mobile device, where the initiating is based at least partially on a user of the mobile device inputting one or more inputs into the mobile device. As represented by block 304, the proposed transaction is stored, such that a second mobile device and/or a computing device other than the mobile device can access the proposed transaction. In addition, as represented by block 306, the mobile device is configure to receive a designation of one or more mobile devices and/or computing devices other than the mobile device for completing the transaction associated with the proposed transaction. Thereafter, as represented by block 308, a system associated with process flow 300 is configured to provide a notification of a proposed transaction request to the designate one or more mobile devices and/or computing devices. Then, as represented by block 310, the proposed transaction is completed by one of the selected one or more mobile devices and/or computing devices.

Regarding block 302, the phrase “proposed transaction request” generally refers to financial transaction or the like that has been initiated but not yet completed. For example, a proposed transaction request may include a fund transfer, where the details for successfully executing the fund transfer are provided in the transaction requests, such that once the fund transfer is submitted or transmitted no additional input is required from the user making the transaction. In such an example, the details of the transaction request may include a first account from which funds are being transferred, a second account to which the funds will be transferred to, a fund amount or value, a fund transfer time and/or date, and/or the like. It will be understood that a proposed transaction request can include any number and/or type of transaction(s) involving a financial account or the like. For example, in some embodiments, the proposed transaction request referred to in block 302 is for: withdrawing cash; depositing cash and/or checks; checking account balances; making payments to creditors (e.g., paying monthly bills; paying federal, state, and/or local taxes and/or bills; etc.); sending remittances; transferring balances from one account to another account; loading money onto stored value cards; donating to charities; and/or the like. As another example, a proposed transaction request may include a credit account balance transfer, where the details for successfully executing the balance transfer are provided between two computing devices, such that using a first computing device a user provides at least part of the information necessary for completing the transaction and that a second user or the user, using a second computing device, provides a second part of the information for completing the transaction, such that once the balance transfer is transmitted to a financial institution no additional input is required from the user(s) making the transaction.

Still regarding block 302, the inputs may be input by the user of the mobile device in any way. For example, in some embodiments, the mobile device includes a keyboard, microphone, and/or one or more other user input devices for inputting the one or more user inputs. As another example, in some embodiments, the mobile device presents, via a touchscreen display of the mobile device, one or more fields, buttons, drop-down menus, and/or other user interface features that enable the customer to input and/or communicate information to the mobile device. In some embodiments, the user actually enters account numbers, transaction amounts, payee names, and/or other information into the mobile device, whereas, in other embodiments, the user communicates information to the mobile device by selecting buttons and/or other user interface features that are provided to the user by the mobile device.

In some embodiments, the mobile device used for initiating the transaction requests is a non-trusted device. In such an embodiment, a mobile banking transaction cannot be completed using a non-trusted device. A non-trusted device, in some embodiments, is a device that is either not designated by the user as a trusted device or is not registered with a server for transmitting and/or completing the transaction as a registered device. As a user preference and/or a setup process for using a mobile banking application on a mobile device, a user must designate one or more trusted devices that are useable for completing transaction requests using a mobile banking application. Upon designating the one or more trusted devices, a user may proceed to initiate and transmit a transaction request for completion. And, when not using a user-designated trusted device, the transaction request is either denied or stored in a proposed transaction request queue until the user or other designated person accesses a trusted device for transmitting the transaction request and thereby completing the transaction. Thus, in some embodiments, when a user initiates a transaction request using a non-trusted device, the user will store the proposed transaction request, then select another user or a trusted device to whom the transaction request is sent for completing the transaction using a trusted device.

Regarding block 304, the proposed transaction request is stored in a centrally located storage device accessible to two or more computing and/or mobile devices including the mobile device initiating the proposed transaction request. The centrally located storage device may be maintained by the user, a financial institution associated with the user, and/or by a third party. The proposed transaction request may be stored in any form or manner in the centrally located storage device that enables the two or more mobile and/or computing devices to be able to access information associated with the transaction in order to complete the proposed transaction request. As such, in some embodiments, the mobile device can be configured to store the proposed transaction request at a centrally located storage device associated with the one or more accounts that are involved in the proposed transaction request. Each of the one or more accounts that are involved in the proposed transaction request may have one or more mobile devices and/or computing devices that are registered to the one or more accounts and/or configured to access the accounts. As a first example, a husband and a wife may both share a financial account, whereby the financial account is tied to and accessible using a mobile banking application, an online banking website/application, and/or similar online or offline tools for accessing the account. In such an example, the husband may initiate a financial transaction, such a fund transfer, using the mobile banking application on his mobile device and may later store the transaction to a central storage device because he does not have enough information for completing the transfer. Husband may notify his wife for completing the transaction that he initiated using the mobile banking application. Wife may then access the central storage for the stored transaction via a mobile banking application on her mobile device and provide the missing information required for completing the mobile banking transaction. In such an example, the mobile banking transaction is initiated using a first mobile device, then stored by the first mobile device at the central storage, then accessed via the central storage by a second mobile device, and subsequently completed using the second mobile device.

In some embodiments, the storage device associated with the one or more accounts that are involved in the proposed transaction request is maintained by the financial institution of the user. In such embodiments, more than one user may be able to access a proposed transaction request at the storage device by using one or more of a mobile banking application or web application, such as an online banking application, that are offered by the financial institution maintaining the storage device.

In some embodiments, the transaction information associated with the proposed transaction request is stored in the memory of the mobile device of block 302. In such an embodiment, a user of the mobile device may provide a second mobile device and/or user access to the proposed transaction request in the memory of the mobile device for completing the proposed transaction request. This memory may be non-temporary, non-volatile, and/or long-term persistent memory, but in some embodiments, in addition to or instead of storing the transaction information in non-temporary, non-volatile, and/or long-term persistent memory, the mobile device stores the transaction information in temporary and/or volatile memory.

In some embodiments, the mobile device is configured to store the transaction information in a proposed transaction request queue in the central storage device. In some embodiments, this queue is stored in a central storage device of the mobile device. As a specific example, in some embodiments, the mobile device is configured to generate a token associated with the proposed transaction request (e.g., information packages having information associated with the proposed transaction request therein, a transaction code, a transaction identifier, etc.) and then place that token into the proposed transaction request queue in the central storage device. In some embodiments, the token is presented, via a user interface of the mobile device, to the user of the mobile device, such that the user may determine and/or view which proposed transaction request are stored in the queue. In addition, after accessing the proposed transaction queue in the central storage device by second mobile device, the token may be transferred from the proposed transaction request queue of the central storage directly to the second mobile device, such that the user of the second mobile device can complete the transaction based at least partially on the token. In some embodiments, the token is readable and/or executable by a processing device associated with the second mobile device, even though, in some embodiments, the token is not readable to, and/or viewable by, the user of the second mobile device. In some embodiments, the token is removed, deleted, and/or erased from the proposed transaction request queue after the proposed transaction request is completed by the second mobile device. Also, it will be understood that the proposed transaction request queue described and/or contemplated herein may be organized and/or viewable to the user of the mobile device as a list, table, dashboard, transaction ledger, and/or in some other format. Further, in accordance with some embodiments, proposed transaction request may be stored in the proposed transaction request queue in the order they were initiated.

In some embodiments, the proposed transaction request remains pending for at least one minute, two minutes, one hour, three days, one month, and/or some other non-trivial and/or appreciable period of time before being completed. In some embodiments, the proposed transaction request remains pending in the central storage device until deleted and/or removed from the central storage device by the user. In some embodiments, the proposed transaction request is only valid for a predetermined period of time. In other words, in some embodiments, the proposed transaction request may expire. For example, in some embodiments, a proposed transaction request is only valid for, and/or will expire after, five minutes, two hours, one day, etc. after being initiated and/or stored on the central storage device (and/or in a proposed transaction request queue). In some embodiments, the user can select (e.g., via the one or more inputs) when the proposed transaction request is to expire and/or for how long the proposed transaction request is to remain valid.

In other embodiments, upon receiving one or more inputs for generating the transaction request, the mobile device transmits the transaction request to another computing and/or mobile device for completing the transaction. For example, a first user on a first mobile device may initiate a transaction request for a fund transfer to a second user. In such an example, the first user may not have the account number of the second and thus, may transmit the transaction request without entering payee account information for the fund transfer. Once the second user receives the partially completed transaction request from the first user, the second may enter his account information into the transaction request for completing the transaction. In some embodiments, the first user may transmit the transaction request to the second user by bumping or tapping together their mobile device. In this way, the contact between the mobile device of the first user and the mobile device of the second user causes the partially completed transaction request to transfer to the mobile device of the second user. In addition, upon the user receiving the partially completed transaction request, portions of the user interface containing the transaction information provided by the first device and/or first user may be locked into to place, such that those items of input from the first user are rendered unchangeable by the second user. Further, portions of the user interface containing the transaction information provided by the first device and/or first user may be blocked, such that inputs provided by the first user cannot be seen by the second user.

Regarding block 306, the mobile device is configured to present to the user one or more mobile devices and/or computing devices for completing the proposed transaction. The one or more mobile devices and/or computing devices for completing the transaction may be presented to the user via the mobile banking application on the mobile device of the user in the form of a list, table, dashboard, and/or some other format for displaying devices available for completing the transaction. The one or more mobile devices and/or computing devices for completing the transaction are different from the mobile device that initiated the transaction. In some embodiments, the one or more mobile devices and/or computing devices that are presented to the user for completing the transaction include one or more other mobile devices and/or computing devices of the user. For example, the user may initiate a transaction via a mobile banking application on his mobile device, but may then store the transaction in a central storage device for completion at a later time. In such an example, based on storing the transaction the mobile banking application presents to the user a list of mobile and/or computing devices for completing the transaction at a later time. Included in the list may be the user's home computer, a second mobile device of the user, and/or a mobile device of a second user who has access to the central storage. In this example, the user may select his home computer for completing the transaction because the necessary information for completing the transaction is stored thereon.

In some embodiments, the mobile device is configured to present to the user one or more additional users for completing the proposed transaction. The one or more additional users for completing the proposed transaction may be any individual including an individual who has a banking relationship with the user, an individual having access or is associated to one or more of the accounts involved in the proposed transaction request, an individual who is an intended recipient of proceeds of the transaction, and/or the like. As an example, the mobile device may present a list of additional users including names of the additional users and/or aliases. In such an example, the user may select an alias of a user from the list to whom the user wishes to make a payment. Once the alias of the additional user is selected, the system may provide a notification of a proposed transaction request to a computing device associated with the alias of the user, so that the user can complete the transaction.

In some embodiments, upon selecting a user or computing device, the system is configured to receive a video and/or voice message from the user who initiated the transaction. In such an embodiment, the system is configured to append the video and/or voice message to the proposed transaction request. As an example, a user may provide a video instruction to a second user who is receiving the proposed transaction request for completion. The video instruction may include a series of instructions or requests from the first user for completing the proposed transaction request. It will be understood that a message including text, images, or drawings, or the like may be appending to the proposed transaction request. Similarly, in some embodiments, a user receiving the proposed transaction request for completion may have questions or concerns regarding the proposed transaction and in such an embodiment, the system is also configured to receive a video and/or voice message from the user that can be appended to the proposed transaction request and transmitted back to the user that originated/initiated the transaction request. In this way, the system is configured to allow a two-way communication line to be available to the initiating user and the user who is the recipient of the proposed transaction request. Additionally, the system is configured to store any communications that are appended to the proposed transaction request or otherwise associated or sent with the proposed transaction request. In that way, an accurate record of the transaction is kept together with any additional instructions, so that the information may be audited at a later time.

Regarding block 308, the notification of a proposed transaction request may be presented, in any manner or form, to a user associated with the selected mobile device and/or computing device. In some embodiments, the notification may be presented to a user via a mobile banking application associated with the selected mobile device and/or computing device. In some embodiments, the notification may be provided to a user via an online banking website/application associated with the selected user. The notification may include transaction information relating to the details of the proposed transaction request. The notification to the selected device and/or user may also include a designation or indication of the information that is missing and is required for completing the proposed transaction. As an example, a first user may initiate a proposed fund transfer for a certain amount from a first account of the first user to a second account of a second user, but may only have information, such as an account number, for the first account. In such an example, the information that is necessary for completing the fund transfer is the information for the second account. Thus, the notification provided to the second user will indicate that information for the second account (e.g., account number) is required for completing the proposed transaction.

In some embodiments, the notification to the user and/or to the computing device may include a selectable link. Upon selection, the selectable link in the notification may redirect the user to a web page or user interface for completing the proposed transaction. In some embodiments, upon selecting the link, the user may be redirect to a login page to an online banking account for completing the proposed transaction. In another embodiment, upon selecting the link, a mobile banking application on a mobile device of the user may be initiated for completing the proposed transaction. Additionally, in some embodiments, the notification comprises one or more input boxes for providing information for completing the proposed transaction.

Regarding block 310, using a second mobile device and/or a computing device other than the mobile device used for initiating the proposed transaction request, the proposed transaction is then completed. It will be understood that a user of the second mobile device and/or the computing device “completes” the proposed transaction request when the second mobile device performs one or more meaningful actions relevant to the proposed transaction request, such as for example, transferring funds, providing an account balance, performing an online bill pay, opening a new account, and/or the like. In addition, upon the proposed transaction request being completed, the system is configured to present a notification that the transaction is complete to the user who originated/initiated the transaction request.

A portion of the above describes registered devices according to one embodiment of the present invention. An example of a system for registering devices is described in U.S. patent application Ser. No. 13/749,293 titled Application Usage In Device Identification Program, the contents of which are incorporated herein by reference.

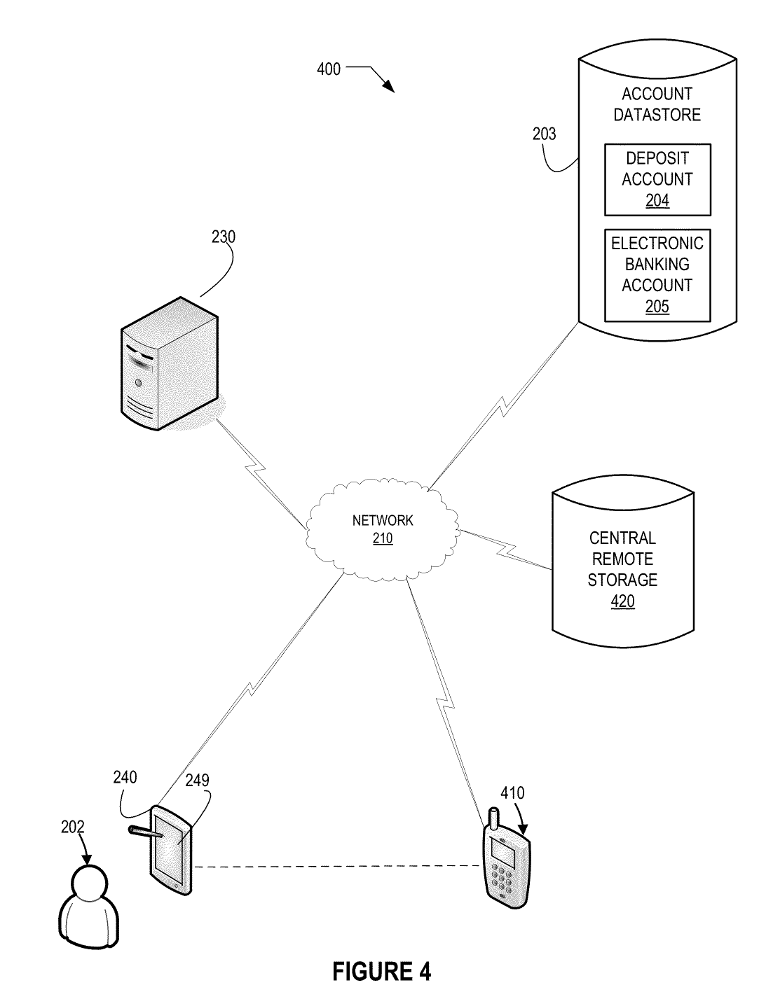

Referring now to FIG. 4, a system 400 for initiating and completing proposed transaction request using different devices is provided, in accordance with an embodiment of the present invention. As illustrated, system 400 has many of the same components as system 200 including a network 210, one or more financial institution servers 230, an account datastore 203, and a mobile device 240. However, system 400 further includes a second consumer device 410 and a central remote storage 420. Central remote storage 420, in some embodiments, is also maintained by the same financial institution (e.g., bank) that maintains the account datastore 203 and the authorization server 230. In accordance with some embodiments, the consumer device 410 is associated with the holder 202, and/or is carried, operated, controlled, possessed, and/or owned by the holder 202. In other embodiment, consumer device 410 is associated with a user who is the holder 202.

As shown in FIG. 4, the mobile device 240, consumer device 410, and central remote storage 420 are each operatively and selectively connected to the network 210, which may include one or more separate network. In this example embodiment, mobile device 240 and consumer device 410 is associated with electronic banking account 205 and thus, each of the mobile device 240 and consumer device 410 having access to central remote storage 420.

Similar to the datastores described in FIG. 2 and otherwise herein, central remote storage 420 can be configured to store any type and/or amount of information. For example, in some embodiments, central remote storage 420 is configured to store transaction information associated with one or more proposed transaction request. In some embodiments, the central remote storage 420 includes one or more queues (e.g., proposed transaction request queue), lists, tables, dashboards, ledgers, etc. for organizing, displaying, and/or storing one or more proposed transaction requests. The central remote storage 420 may include any one or more storage devices, including, but not limited to, datastores, databases, and/or any of the other storage devices typically associated with a mobile device, server, and/or computer system. It will also be understood that the central remote storage 420 may store information in any known way, such as, for example, by using one or more computer codes and/or languages, alphanumeric character strings, data sets, figures, tables, charts, links, documents, and/or the like. Further, in some embodiments, the central remote storage 420 includes information associated with one or more applications, such as, for example, the mobile banking application 247. In some embodiments, central remote storage 420 provides a real-time or near real-time representation of the information stored therein, so that, for example, when a processor accesses the central remote storage 420, the information stored therein is current or nearly current.

Consumer device 410 may be or include a computer system, server, multiple computer system, multiple servers, or some other computing device configured for use by a user, such as a desktop, laptop, personal digital assistant (PDA), tablet, or a mobile communications device, such as a smartphone. In some embodiments, consumer device 410 may be configured substantially similar to mobile device 240, as shown in FIG. 2A. Similar to mobile device 240, consumer device 410 can be configured to initiate, perform, transmit, complete, and/or facilitate any portion of any embodiment described and/or contemplated herein. In some embodiments, consumer device 410 is configured to receive a transmission from mobile device 240 of a proposed transaction request, which consumer device 410 is configured to complete by receiving one or more inputs from a user for completing the proposed transaction request. As another example, in some embodiments, consumer device 410 is configured to access central remote storage 420 for retrieving a proposed transaction request previously stored by mobile device 240, such that consumer device 410 can be used to complete the proposed transaction request.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

To supplement the present disclosure, this application further incorporates entirely by reference the following commonly assigned patent applications: U.S. patent application Ser. No. ______ for a “Remote Control for Online Banking,” filed Jul. 19, 2013; U.S. patent application Ser. No. ______ for “Online Banking Alerts,” filed Jul. 19, 2013; U.S. patent application Ser. No. ______ for “Customer-Defined Online Banking Access Restrictions,” filed Jul. 19, 2013; U.S. patent application Ser. No. ______ for “Restricted Access to Online Banking,” filed Jul. 19, 2013; U.S. patent application Ser. No. ______ for “Offline Mobile Banking,” filed Jul. 19, 2013; U.S. patent application Ser. No. ______ for “Completing Mobile Banking Transactions from Trusted Location,” filed Jul. 19, 2013; U.S. patent application Ser. No. ______ for an “Online Session Transfer,” filed Jul. 19, 2013; and U.S. patent application Ser. No. ______ for “Systems for Managing Account Aggregators Access to Financial Account Information,” filed Jul. 19, 2013.

What is claimed:

1. A system for completing a mobile banking transaction using two or more devices, the system comprising:
a mobile device;
a storage device;
a module stored in the storage device, where the module comprises executable instructions that when executed by the processing device causes the processing device to:
initiate, via the mobile device, a transaction request for a mobile banking transaction;
store the transaction request for the mobile banking transaction in a queue for mobile banking transaction requests;
retrieve from the queue, using a consumer device, the transaction request for the mobile banking transaction, wherein the consumer device is different from the mobile device; and
complete, using the consumer device, the transaction request for the mobile banking transaction.

2. The system of claim 1, wherein the queue for mobile banking transaction requests is located in a centrally storage device accessible to the mobile device and computing device.

3. The system of claim 2, wherein the queue is associated with one or more accounts involved in the transaction request for the mobile banking transaction.

4. The system of claim 1, wherein the processing device is further configured to present a notification to the computing device of the transaction request being stored in the queue.

5. The system of claim 4, wherein the notification to the computing device comprises a selectable feature that when selected by a user of the computing device initiates, on the computing device, a mobile banking application or an online banking application for completing the transaction request.

6. The system of claim 1, wherein the processing device is further configured to:
present, via the mobile device, one or more computing devices for completing the transaction request;
receive, via the mobile device, a selection of one of the one or more computing devices for completing the transaction request; and
provide a notification to the selected one of the one or more computing device, wherein the notification comprises information for completing the transaction request using the selected computing device.

7. The system of claim 1, wherein the transaction request for the mobile banking transaction is a financial transaction including one or more of a fund transfer, a balance transfer, a checking an account balance, a bill payment, a financial account setup, an opening a new financial account, electronically depositing a check or negotiable instrument, and/or an ordering checks.

8. A computer-implemented method for completing a mobile banking transaction using two or more devices, the computer-implemented method comprising:
providing a computer processor executing non-transitory computer-readable instruction code specifically structured to cause the computer processor to:
initiate, via a mobile device, a transaction request for a mobile banking transaction;
store the transaction request for the mobile banking transaction in a queue for mobile banking transaction requests;
retrieve from the queue, using a consumer device, the transaction request for the mobile banking transaction, wherein the consumer device is different from the mobile device; and
complete, using the consumer device, the transaction request for the mobile banking transaction.

9. The computer-implemented method of claim 8, wherein the queue for mobile banking transaction requests is located in a centrally storage device accessible to the mobile device and computing device.

10. The computer-implemented method of claim 9, wherein the queue is associated with one or more accounts involved in the transaction request for the mobile banking transaction.

11. The computer-implemented method of claim 8, wherein the processing device is further configured to present a notification to the computing device of the transaction request being stored in the queue.

12. The computer-implemented method of claim 11, wherein the notification to the computing device comprises a selectable feature that when selected by a user of the computing device initiates, on the computing device, a mobile banking application or an online banking application for completing the transaction request.

13. The computer-implemented method of claim 8, wherein the computer processor is further executing computer-readable instruction code specifically configured to cause the computer processor to:
present, via the mobile device, one or more computing devices for completing the transaction request;
receive, via the mobile device, a selection of one of the one or more computing devices for completing the transaction request; and
providing a notification to the selected one of the one or more computing device, wherein the notification comprises information for completing the transaction request using the selected computing device.

14. The computer-implemented method of claim 8, wherein the computer processor is further executing computer-readable instruction code specifically configured to cause the computer processor to:
wherein the transaction request for the mobile banking transaction is a financial transaction including one or more of a fund transfer, a balance transfer, a checking an account balance, a bill payment, a financial account setup, an opening a new financial account, electronically depositing a check or negotiable instrument, and/or an ordering checks.

15. A computer program product for completing a mobile banking transaction using two or more devices, the computer program product comprising a non-transitory computer-readable medium, wherein the non-transitory computer-readable medium comprises one or more computer-executable program code portions that, when executed by a computer, cause the computer to:
initiate, via a mobile device, a transaction request for a mobile banking transaction;
store the transaction request for the mobile banking transaction in a queue for mobile banking transaction requests;
retrieve from the queue, using a consumer device, the transaction request for the mobile banking transaction, wherein the consumer device is different from the mobile device; and
complete, using the consumer device, the transaction request for the mobile banking transaction.

16. The computer program product of claim 15, wherein the queue for mobile banking transaction requests is located in a centrally storage device accessible to the mobile device and computing device.

17. The computer program product of claim 16, wherein the queue is associated with one or more accounts involved in the transaction request for the mobile banking transaction.

18. The computer program product of claim 15, wherein the processing device is further configured to present a notification to the computing device of the transaction request being stored in the queue.

19. The computer program product of claim 18, wherein the notification to the computing device comprises a selectable feature that when selected by a user of the computing device initiates, on the computing device, a mobile banking application or an online banking application for completing the transaction request.

20. The computer program product of claim 15, wherein the one or more computer-executable program code portions, when executed by the computer, cause the computer to:
present, via the mobile device, one or more computing devices for completing the transaction request;
receive, via the mobile device, a selection of one of the one or more computing devices for completing the transaction request; and
providing a notification to the selected one of the one or more computing device, wherein the notification comprises information for completing the transaction request using the selected computing device.
